(19) United States
(12) Patent Application Publication
(10) Pub. No.: US 2021/0076156 A1
(43) Pub. Date: Mar. 11, 2021

(54) CONFERENCE ROOM INTERFACE SYSTEM

(71) Applicant: WeWork Companies LLC, New York, NY (US)

(72) Inventors: Josh Abrams, New York, NY (US); Ben Fullerton, San Francisco, CA (US); Ian Jaye, San Francisco, CA (US); Cody Henshaw, San Francisco, CA (US); Jeffrey Coulter Smith, New York, NY (US)

(21) Appl. No.: 16/923,981

(22) Filed: Jul. 8, 2020

Related U.S. Application Data
(60) Provisional application No. 62/871,657, filed on Jul. 8, 2019.

(51) Int. Cl. H04W 4/02; G08B 5/36

(52) U.S. Cl. CPC H04W 4/023; G08B 5/36

(57) ABSTRACT

An interface system associated with a conference room of a workspace including a tag device associated with the conference room of the workspace, wherein the tag device is configured to: present a visual indication of a current status of use of the conference room that is based on a reservation system associated with the conference room; and provide information identifying the conference room to a mobile device when the mobile device is proximate to the tag device. The mobile device can include a mobile application associated with the reservation system that is configured to present user-selectable options to control one or more aspects of the conference room during an activity within the conference room.

### CROSS-REFERENCE TO RELATED APPLICATIONS

This application claims priority to U.S. Provisional Patent Application No. 62/871,657, filed Jul. 8, 2019, entitled CONFERENCE ROOM INTERFACE SYSTEM, the disclosure of which is incorporated herein by reference in its entirety.

### BACKGROUND

Many workers in service or other industries typically use or need an office in which to work, which often takes the form of thousands of square feet of office space leased or owned by the worker's employer. Some workers are self-employed or work for small companies that may have a more difficult time finding an acceptable space in which to work. These self-employed or small company workers—as well as workers for large businesses—have turned to coworking arrangements.

Coworking is a self-directed, collaborative, and flexible work style, often based around a common interest, such as geographic location, shared social values, etc. Coworking typically employs a shared workplace and independent activities among individuals working with the workplace. Unlike a typical office, coworking often allows workers from different organizations to share resources such as conference rooms, break rooms, receptionists, IT professionals, telecommunications resources, etc. Coworking workers are relieved of the effort of finding, renting, outfitting, supplying, and managing their own space.

Coworking arrangements are attractive to work-at-home professionals, independent contractors, independent scientists, and people who travel frequently—typically workers who would otherwise end up working in relative isolation (though coworking is in no way limited to such workers). Coworkers can enjoy a social gathering of a group of people who are still working independently, but who may share certain values and who are interested in the synergy that can happen from working with people who value working in the same place alongside each other. Coworking offers a solution to the problem of isolation that many freelancers experience while working at home, while at the same time letting them escape the distractions of home. Moreover, some larger business see the value in offering coworking arrangements for some of their employees who can enjoy the same benefits noted above, even if a large number of them represent a majority of other workers sharing a common workspace.

### BRIEF DESCRIPTION OF THE DRAWINGS

FIG. 1 is a partial schematic, partial block diagram of a coworking space.

FIG. 2 is a block diagram of a representative mobile device that can display various GUI screens.

FIG. 3 illustrates top and side views of a tag device in accordance with embodiments of the present technology.

FIG. 4 illustrates top and side views of a tag device and a mobile device illustrating activation of a mobile application.

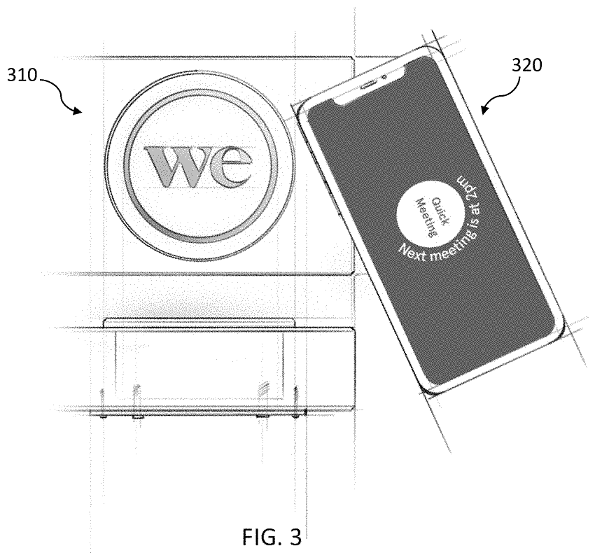

FIGS. 3-8 present various diagrams of a room interface mobile application in accordance with embodiments of the present technology.

FIG. 9 presents perspective views of a broadcast device depicting various conference room statuses.

FIG. 10 illustrates stand-alone interfaces for a corresponding room or space.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, combinations, and alternatives falling within the scope of the technology as defined by the appended claims.

### DETAILED DESCRIPTION

### Overview

In some embodiments, a room interface system, such as a conference room or meeting room interface (e.g., “Space Board”) system is described. The room interface system enables the use of a space (e.g. a conference room) as an interface, where the space presents information about the use and availability of the space at any moment or at future time periods.

In doing so, a room interface system alleviates and/or mitigates friction associated with multiple different groups of members attempting to utilize or reserve a space, as well as enable members, during use, to optimize the functionality of the space during a meeting or other collaborative use, among other benefits.

The room interface system can include a number of different devices or components that facilitate the use of space as an interface. For example, the system can employ a tag (e.g., “Space Dot”) located within a space (e.g., room, phone booth, desk, and so on) and that represents the specific space, as well as provides various information or indicators about current or future use of the space. The tag device, therefore, enables activation of a space as an interface utilized by members within the space. Further, a tag device can also indicate booking, reservation, or use status and/or interact with member mobile devices during various space utilization actions.

As another example, the system can employ an interactive screen or device (e.g., “Space Board) that is located with a space and functions as a virtual assistant for the space. The interactive device can present visual information, audio information (e.g., voiced information), as well as present the status of a space and contextual information related to current or future activities within the space. For example, the screen can facilitate the reservation of an available space via its user interface, can alert users that a meeting is about to end (including information about a next booking), can check in members into a meeting (or otherwise initiate or confirm use of the space for a scheduled meeting) and so on.

As another example, the system can employ a broadcast device (e.g., “Studio Light”) that is located outside of a space and functions to present a use, booking, or reservation status of a space. The broadcast device may present various different colors (or patterns of display of the colors) that broadcast to members of a workspace the availability or other statuses for the associated space.

Thus, the room interface system facilitates the activation of space, the interactivity of space, and/or the state of a space, enabling members of a workspace to optimally and efficiently interface with a space when: (1) seeking to use the space, (2) reserving use of the space, (3) using the space, and/or (4) completing use of the space (e.g., ending a meeting). Described in detail below are systems and methods for facilitating the transformation of a space as an interface to members interacting with the space.

While the various systems and methods are described herein as applied to a co-working facility, the systems and methods are equally applicable to many other environments and are in no way limited to co-working environments. At times, the terms “facility” and “location” are used interchangeably herein; likewise, the terms “member” and “user” are used interchangeably herein. A member or user can be an employee of a third-party company that leases space within the co-working facility or location, though a member could be a sole proprietor. A “community manager” (CM) is a representative of the organization that manages and often leases space to members within a co-working facility. The CM is effectively an office manager for all of the different companies and members within a building, floor of the building, or portion of a floor within a building. A “community team” includes not only the CM but also other representatives of the organization offering the co-working space to third parties, and can include IT professionals, janitorial employees, security personnel, etc.

In the following description, for the purposes of explanation, numerous specific details are set forth in order to provide a thorough understanding of implementations of the present technology. It will be apparent, however, to one skilled in the art that implementations of the present technology can be practiced without some of these specific details. The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

### Examples of a Suitable Environment

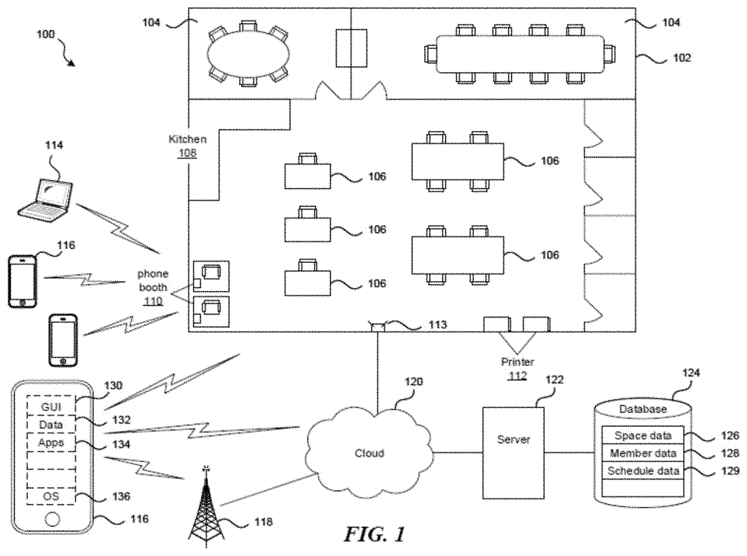

Several implementations are discussed below in more detail with reference to the figures. FIG. 1 illustrates an overview of an environment 100 in which some implementations of the disclosed technology can operate. Environment 100 includes a co-working facility 102 that includes conference rooms 104, desks 106 and a kitchen area 108. The co-working facility also includes additional resources such as phone booths 110 and printers 112, as well as IT infrastructures such as wireless routers 113 to provide wireless local networking (e.g. IEEE 802.11 Wi-Fi networking), networked or “smart” thermostats, smart lighting, and so forth.

Members who use the co-working facility 102 typically have one or more laptop computers 114, mobile phones 116, and other data processing devices that can connect to one or more servers 122 via the wireless routers 113 or via WWAN/cellular base stations 118 and via a network or cloud 120. The server 122 is coupled to one or more databases 124. The database 124 stores data such as space data 126, member data 128 and schedule data 129. The space data 126 includes data related to physical layout and resources within the co-working facility 102. The member data 128 includes information regarding members who work within the facility 102, and can include information regarding rental or lease data, personal information, preferences, and so forth. The schedule data 129 includes information regarding scheduling of resources within the facility 102, such as the conference rooms 104, desks 106, and so forth.

As described below, each member can access or schedule resources within the facility 102 or elsewhere via one or more applications running on the laptop 114 or mobile device 116. As shown, the mobile device can include an operating system 136, one or more applications 134, application data 132 and a graphical user interface (GUI) 130.

While server 122 is displayed logically as a single server 122, the system can employ a distributed computing environment encompassing multiple computing devices located at the same or at geographically disparate physical locations. In some implementations, each server 122 can correspond to a group of servers.

Network or cloud 120 can be any network, ranging from a wired or wireless local area network (LAN), to a wired or wireless wide area network (WAN), to the Internet or some other public or private network. While the connections between the server 122 and the cloud 120 and database 124 are shown as separate connections, these connections can be any kind of local, wide area, wired, or wireless network, public or private.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

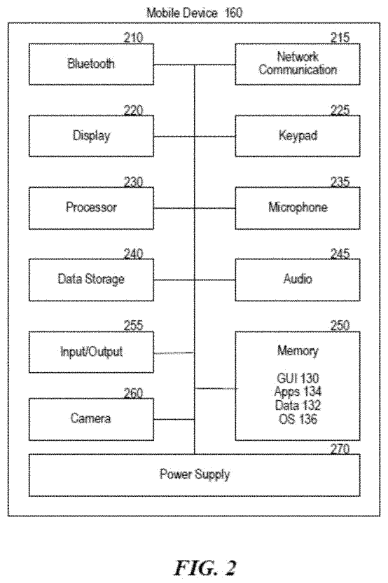

FIG. 2 is a block diagram of a representative mobile device 116 that may serve as a handset on which a member app operates in accordance with embodiments herein, though much of the same components apply equally to laptop 114. Mobile device 116 typically includes a processor 230 for executing processing instructions, a data storage medium component 240 (e.g., hard drive, flash memory, memory card, etc.), volatile memory and/or nonvolatile memory 250, a power supply 270, one or more network interfaces (e.g., Bluetooth Interface 210 or Network Communication Interface 215, which enables the mobile phone to communicate by transmitting and receiving wireless signals using licensed, semi-licensed or unlicensed spectrum over a telecommunications network), an audio interface 245, a display 220, a keypad or keyboard 225, a microphone 235, one or more cameras 260, and other input and/or output interfaces 255. The various components of the mobile device may be interconnected via a bus. The volatile and nonvolatile memories generally include storage media for storing information such as processor-readable instructions, data structures, program modules, or other data. The stored information includes instructions, which when executed by the processor 230, perform operations for performing the functions as described in detail below.

Mobile device 116 may be virtually any device for communicating over a wireless network. Such devices include application servers or mobile telephones, Personal Digital Assistants (“PDAs”), radio frequency devices, infrared devices, handheld computers, laptop computers, wearable computers, tablet computers, pagers, smart watches, integrated devices combining one or more of the preceding devices, and/or the like.

### Examples of a Conference Room Interface System

As described herein, the room interface system enables a space or room (e.g., conference room, meeting room, team room, phone booth, member desk, pod or grouping of desks, and so on) to become an interface to members utilizing the space or room.

FIG. 3 illustrates the activation of a space using a tag device 310. The tag device 310 is captured by a mobile device 320 (e.g., via an image taken by the mobile device or via a Bluetooth association between devices). Once the tag is captured, the mobile device 320 identifies the space associated with the tag (e.g. a certain conference room), and displays information associated with the room and activities within the room (e.g., a current meeting within the room) via an associated mobile application.

The mobile device 320 can also present various user-selectable options to be performed with respect to the space (or associated activities), including controlling various environmental functions of the space (e.g., controlling the lights, modifying the temperature, closing blinds, activating moving boards or other presentation components, controlling video-conferencing, and so on), and/or controlling parameters of the activity (e.g., changing the booking duration, ordering food or coffee to the space, and so on).

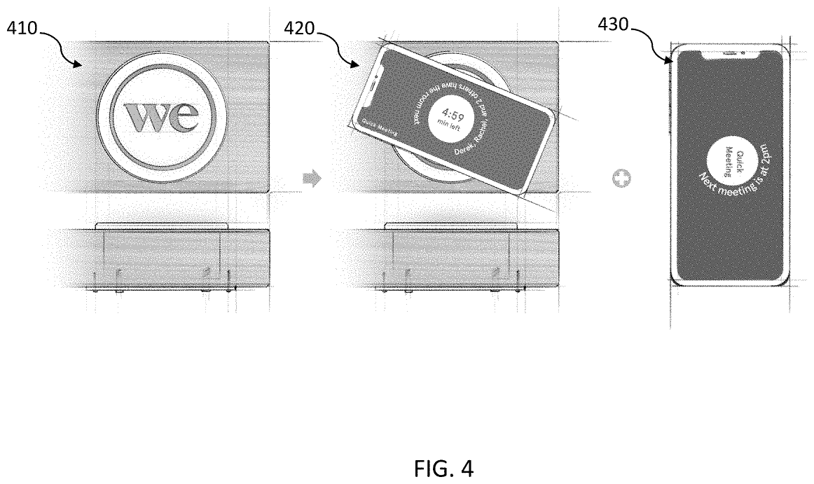

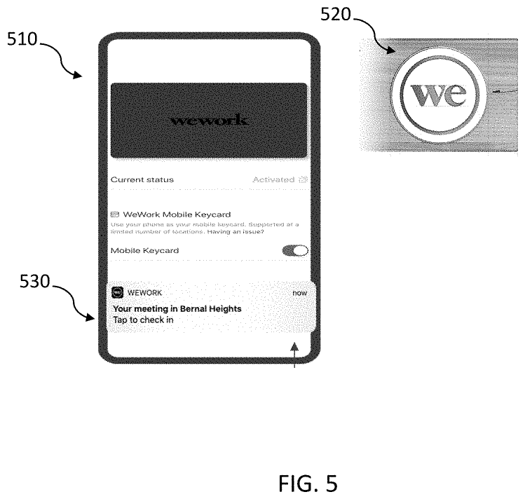

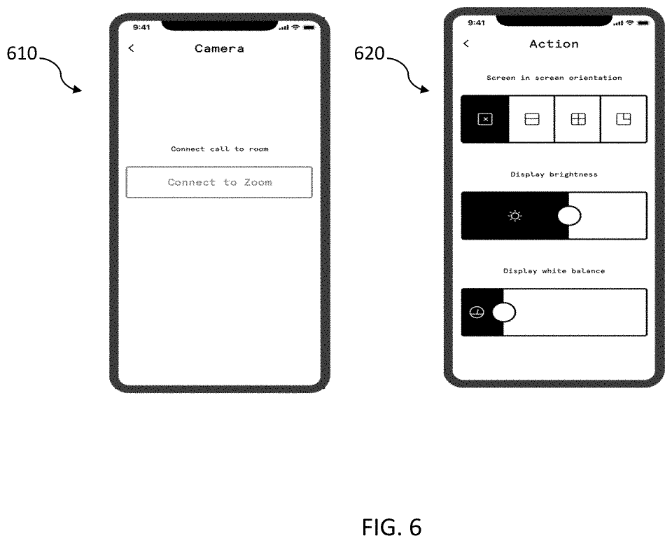

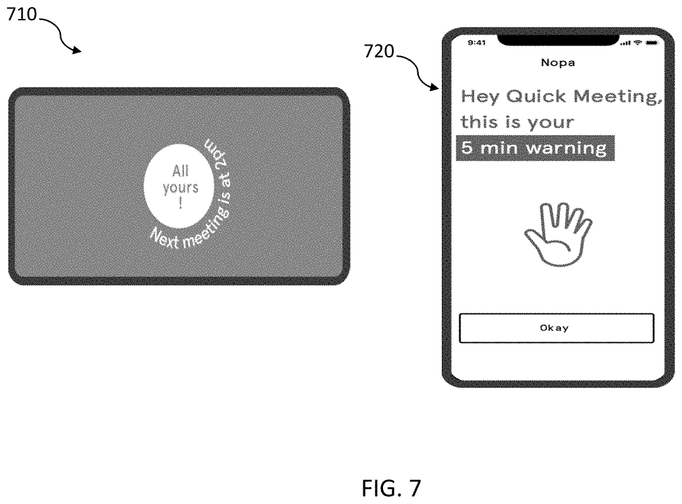

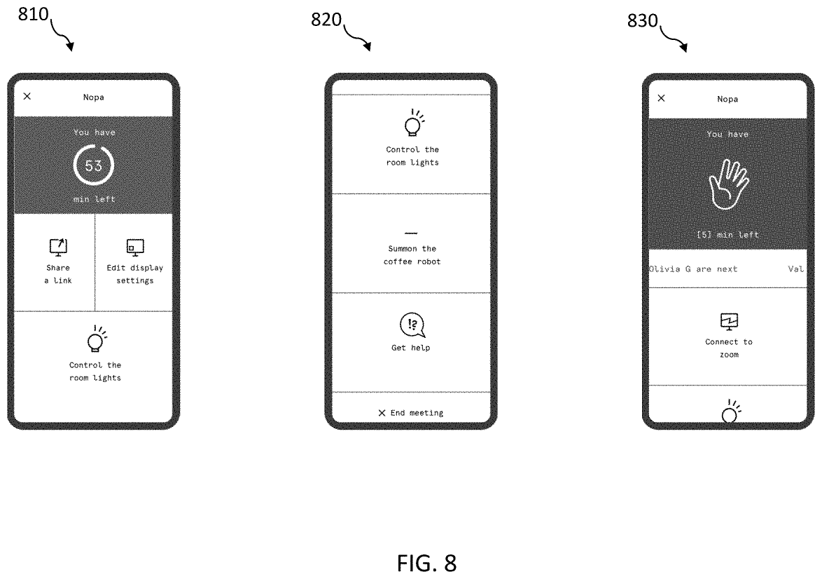

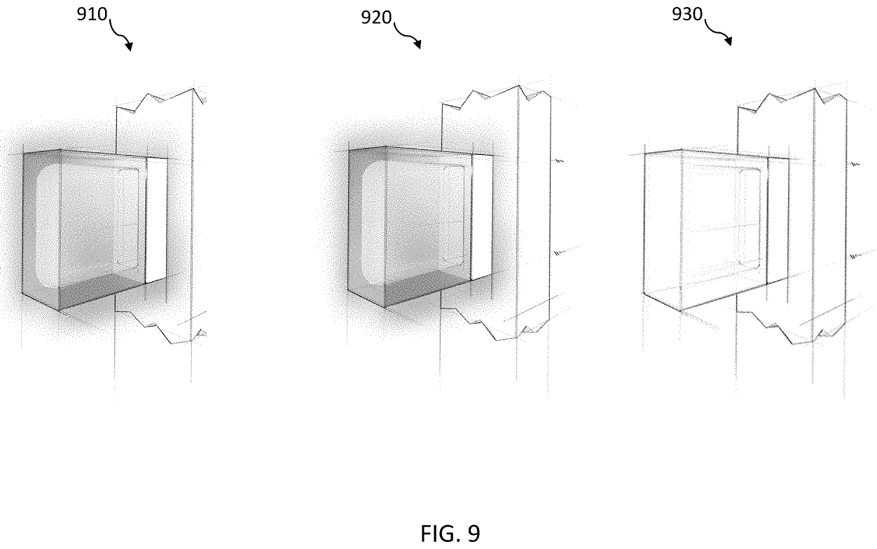

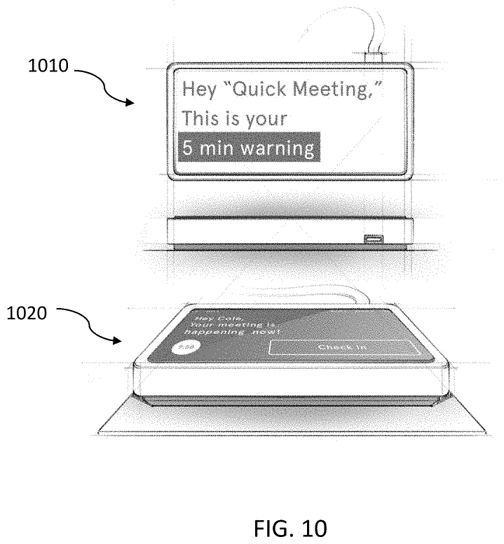

FIG. 4 depicts a tag device 410. The tag device 410 can glow a variety of different colors to indicate the status of the space. For example, the tag device 410 can be associated with a room reservation system, and present information associated with the daily use of the space. Red may indicate the room is in use (or about to be in use), blue indicates the room is actively being used, yellow indicates a meeting is to end soon, orange may indicate a meeting has ended, and so on.

Placing a mobile device 420 on or near the tag device 410 can cause an associated mobile application to present controls for a meeting via the mobile device 420. However, when the mobile device 420 moves to a resting or static position (e.g., it is placed on a table for a threshold period of time), the mobile application 430 presents an interactive display for the meeting (e.g., meeting information, remaining duration, and so on). In some implementations the threshold period of time can be between 1 to 5 seconds. The mobile application can revert back to presenting controls when picked up by a member (e.g., triggered by an accelerometer or gyroscope within the device 420).

FIG. 5 depicts use of a tag device to confirm use of a space. A member enters a space and places his/her mobile device 510 proximate to a tag device (e.g., an interactive device and/or a simple information tag) 520. An associated mobile application determines the member is within the space, and presents a notification or other graphical element 530 that facilitates the member checking into the space for a scheduled meeting.

FIG. 6 depicts the control of a space via a mobile application. For example, user interface 610 enables the control of a video-conferencing system (e.g., Zoom) within the space, and user interface 620 enables the control of the space itself, such as control of the lights, control of various displays within the space, control of display settings, and so on.

Further, FIG. 7 depicts the interactivity between the space and the member. For example, user interface 710 depicts a confirmation and updated status of the space, and user interface 720 depicts a message associated with a current state of an activity within the space (e.g., a meeting is ending shortly), information about a next activity, and so on.

FIG. 8 depicts additional use of a mobile device as an interactive device. For example, user interface 810 depicts various actions to control use of the space, user interface 820 depicts additional actions to communicate with systems (e.g., a coffee robot system) outside of the space, and user interface 830 depicts information associated with a current and next use of the space (e.g., who has next booked the space). These user interface can also be employed as a stand-alone display or interactive device within the space, as described herein.

FIG. 9 depicts various states of a broadcast device. The broadcast device, as described herein, is positioned or located outside of a space (e.g., similar to an “on-air” indicator for a radio or television studio), letting outside users (e.g., members of a space doing laps around a workspace seeking an available room). The broadcast device can be a variety of designs or forms, from a tablet type display to an elegant visual indicator (e.g., a frosted acrylic light diffuser over a strip of LEDs that present colors associated with a status of a room), and so on.

As depicted, the broadcast device presents a color that indicates room occupancy and/or booking status of a room, such as a green color 910 that indicates a room is not booked and unoccupied, an orange color 920 that indicates the room is being booked or will be occupied within a certain time period (e.g., 5 or 10 minutes), a light color 930 (or no color) that indicates the room is booked and/or occupied. The device can present gradual changes in the presented colors, indicating and representing the changing statuses of various spaces over time. Thus, the device can depict booking status and/or occupancy status (derived from occupancy sensor information), or both, such as where an “empty, un-booked” room presents a different color than an “occupied, un-booked” room, or a “occupied, booked” room.

FIG. 10 depicts an interactive device 1010 within a space. The interactive device 1010, as described herein, acts as a stand-alone interface to a digital twin of a room or space, such as all information known about the space at any given time (e.g., booking status, use status, current or future activities, and so on). For example, the device 1010 presents an ambient status color that identifies a room is booked, a room is un-booked, a room is occupied, a meeting has begun, a meeting is ending shortly, a meeting has ended (or ended a minute ago), and so on.

Further, an additional device 1020 (or device 1010) can facilitate user input or actions, such as actions to reserve a room, check into a meeting, adjust parameters of the space or meeting, and so on. The devices 1010, 1020, therefore, continuously provide context information for a meeting or other activity and status information for the space, enabling the space to act as an interface to the members into a digital system associated with the space that handles booking of the space, use of the space, and so on.

The room interface system, therefore, provides various devices or components to enable users to interface with a space provided via a booking or reservation system. Using presented light and other unobtrusive presentations, the system enables members to learn information about a space and utilize the space in a harmonious and collaborative manner, minimizing issues associated with overuse or unknown use of a space by other members, among other benefits.

Although specific embodiments of, and examples for, the technology are described above for illustrative purposes, various embodiments are possible within the scope of the technology. For example, an interface system associated with a conference room of a workspace in accordance with embodiments of the present technology can comprise a tag device associated with the conference room of the workspace, wherein the tag device is configured to: present a visual indication of a current status of use of the conference room that is based on a reservation system associated with the conference room; and provide information identifying the conference room to a mobile device when the mobile device is proximate to the tag device. In some embodiments, the mobile device includes a mobile application associated with the reservation system that is configured to present user-selectable options to control one or more aspects of the conference room during an activity within the conference room.

In some embodiments, the mobile application presents an interactive display for a meeting when the mobile device remains in a static position for at least a threshold period of time. In some embodiments, the interactive display includes at least a meeting name and a remaining duration of the meeting. In some embodiments, the mobile application reverts to presenting user-selectable options to control one or more aspects of the conference room when the mobile device is moved subsequent to presenting the interactive display. In some embodiments, the tag device is attached to a table located in the conference room. In some embodiments, the tag device presents a certain color of light based on the current status of the conference room.

A visual display device in accordance with embodiments of the present technology can be configured to be fixed to an outside area of a reservable room within a workspace. The visual display device can comprise one or more indicator lights that present multiple different colors of light based on a current status of use of the reservable room and a controller device. The controller device can receive instructions from a reservation system associated with the workspace, and presents a certain color of light based on the current status of the reservable room, wherein the current status of the reservable room is provided by the reservation system. In some embodiments, the status of the reservable room is unoccupied and not booked, unoccupied and booked, or occupied and booked.

A conference room interface system in accordance with embodiments of the present technology can comprise a reservation system associated with one or more conference rooms, one or more tag devices each associated with a corresponding one of the one or more conference rooms, and one or more visual display devices each fixed to an outside area of a corresponding one of the one or more conference rooms. Each tag device can be configured to present a visual indication of a current status of use of the associated conference room that is based on the reservation system and provide information identifying the conference room to a mobile device when the mobile device is proximate to the tag device. In some embodiments, the mobile device includes a mobile application associated with the reservation system that is configured to present user-selectable options to control one or more aspects of the conference room during an activity within the conference room. Each visual display device can comprise one or more indicator lights that present multiple different colors of light based on the current status of use of the associated conference room and a controller device. The controller device can receive instructions from the reservation system, and presents a certain color of light based on the current status of the conference room, wherein the current status of the conference room is provided by the reservation system.

In some embodiments, the mobile application presents an interactive display for a meeting when the mobile device remains in a static position for at least a threshold period of time. In some embodiments, the interactive display includes at least a meeting name and a remaining duration of the meeting. In some embodiments, the mobile application reverts to presenting user-selectable options to control one or more aspects of the conference room when the mobile device is moved subsequent to presenting the interactive display. In some embodiments, the tag device is attached to a table located in the conference room. In some embodiments, the tag device presents a certain color of light based on the current status of the conference room. In some embodiments, a status of the conference room is unoccupied and not booked, unoccupied and booked, or occupied and booked.

This application is related to U.S. patent application Ser. No. 16/250,983 filed Jan. 17, 2019 having Attorney Docket No. 128135-8002.US01, titled “RESERVATION SYSTEM IN A SHARED WORKSPACE;” U.S. patent application Ser. No. 16/835,095 filed Mar. 30, 2020, having Attorney Docket No. 128135-8015.US01, titled “MODULAR STRUCTURES FOR CREATING FUNCTIONAL SPACES;” U.S. patent application Ser. No. 16/833,278 filed Mar. 27, 2020, having Attorney Docket No. 128135-8016.US01, titled “PROVIDING PHYSICAL SPACES, RESOURCES, AND INFORMATION TO USERS AND MANAGERS WITHIN A WORKSPACE, SUCH AS VIA A MEMBER APP;” U.S. Patent Application No. 63/001,168 filed Mar. 27, 2020 having Attorney Docket No. 128135-8017.US01, titled “DIGITAL PLATFORM FOR WORKSPACE;” U.S. Patent Application No. 63/001,178 filed Mar. 27, 2020, Attorney Docket No. 128135-8018.US01, titled “SPATIAL DATA INSIGHTS AND ANALYTICS;” U.S. patent application Ser. No. 16/835,012 filed Mar. 30, 2020 having Attorney Docket No. 128135-8020.U502, titled “AUTOMATIC OFFICE SPACE LAYOUT;” U.S. patent application Ser. No. 16/863,891 filed Apr. 30, 2020 having Attorney Docket No. 128135-8021.US01, titled “AUTOMATICALLY PROCESSING TICKETS;” U.S. patent application Ser. No. 16/920,149 filed Jul. 2, 2020 having Attorney Docket No. 128135-8050.US01, titled “DEMOUNTABLE MODULAR WALL STRUCTURES,” all of which are herein incorporated by reference in their entireties.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

I/We claim:

1. An interface system associated with a conference room of a workspace, the interface system comprising:
a tag device associated with the conference room of the workspace, wherein the tag device is configured to:
present a visual indication of a current status of use of the conference room that is based on a reservation system associated with the conference room; and
provide information identifying the conference room to a mobile device when the mobile device is proximate to the tag device,
wherein the mobile device includes a mobile application associated with the reservation system that is configured to present user-selectable options to control one or more aspects of the conference room during an activity within the conference room.

2. The interface system of claim 1, wherein the mobile application presents an interactive display for a meeting when the mobile device remains in a static position for at least a threshold period of time.

3. The interface system of claim 2, wherein the interactive display includes at least a meeting name and a remaining duration of the meeting.

4. The interface system of claim 2, wherein the mobile application reverts to presenting user-selectable options to control one or more aspects of the conference room when the mobile device is moved subsequent to presenting the interactive display.

5. The interface system of claim 1, wherein the tag device is attached to a table located in the conference room.

6. The interface system of claim 1, wherein the tag device presents a certain color of light based on the current status of the conference room.

7. A visual display device configured to be fixed to an outside area of a reservable room within a workspace, the visual display device comprising:
one or more indicator lights that present multiple different colors of light based on a current status of use of the reservable room; and
a controller device that:
receives instructions from a reservation system associated with the workspace, and
presents a certain color of light based on the current status of the reservable room,
wherein the current status of the reservable room is provided by the reservation system.

8. The visual display device of claim 7, wherein a status of the reservable room is unoccupied and not booked, unoccupied and booked, or occupied and booked.

9. A conference room interface system, the interface system comprising:
a reservation system associated with one or more conference rooms;
one or more tag devices each associated with a corresponding one of the one or more conference rooms, wherein each tag device is configured to:
present a visual indication of a current status of use of the associated conference room that is based on the reservation system; and
provide information identifying the conference room to a mobile device when the mobile device is proximate to the tag device,
wherein the mobile device includes a mobile application associated with the reservation system that is configured to present user-selectable options to control one or more aspects of the conference room during an activity within the conference room; and
one or more visual display devices each fixed to an outside area of a corresponding one of the one or more conference rooms, wherein each visual display device comprises:
one or more indicator lights that present multiple different colors of light based on the current status of use of the associated conference room; and
a controller device that:
receives instructions from the reservation system, and
presents a certain color of light based on the current status of the conference room,
wherein the current status of the conference room is provided by the reservation system.

10. The conference room interface system of claim 9, wherein the mobile application presents an interactive display for a meeting when the mobile device remains in a static position for at least a threshold period of time.

11. The conference room interface system of claim 10, wherein the interactive display includes at least a meeting name and a remaining duration of the meeting.

12. The conference room interface system of claim 10, wherein the mobile application reverts to presenting user-selectable options to control one or more aspects of the conference room when the mobile device is moved subsequent to presenting the interactive display.

13. The conference room interface system of claim 9, wherein the tag device is attached to a table located in the conference room.

14. The conference room interface system of claim 9, wherein the tag device presents a certain color of light based on the current status of the conference room.

15. The conference room interface system of claim 9, wherein a status of the conference room is unoccupied and not booked, unoccupied and booked, or occupied and booked.
